(19) United States
(12) Patent Application Publication
(10) Pub. No.: US 2025/0242729 A1
(43) Pub. Date: Jul. 31, 2025

(54) SEAT, IN PARTICULAR VEHICLE SEAT

(71) Applicant: Adient US LLC, Plymouth, MI (US)

(72) Inventors: Thomas FROTZ, Wermelskirchen (DE); Daniel BAHR, Kürten (DE); Andreas SCHMITZ, Burscheid (DE); Rudolf Wilhelm HEMMELRATH, Leverkusen (DE); Markus Manfred MÜLLER, Mechernich (DE); Anja SCHAETZMUELLER, Lindlar (DE)

(21) Appl. No.: 19/036,238

(22) Filed: Jan. 24, 2025

(30) Foreign Application Priority Data
Jan. 26, 2024 (DE) 10 2024 200 735.8
May 29, 2024 (DE) 10 2024 205 006.7

(51) Int. Cl. B60N 2/02; B60N 2/90

(52) U.S. Cl. CPC B60N 2/0284; B60N 2/929

(57) ABSTRACT

A seat, in particular a vehicle seat, having at least one seat part and a leg support movably arranged on the seat part, which is adjustable between an extended lengthening position and a retracted normal position. The leg support has at least a support form part movably arranged relative to the seat part, a form part covering arranged on the support form part and a tensioning device. The tensioning device is configured to keep the form part covering under tension on the support form part in each of two opposing direction of movements during a movement of the support form part relative to the seat part.

### FIELD

The invention relates to a seat, in particular a vehicle seat, having at least one seat part and a leg support arranged on the seat part.

### BACKGROUND

Vehicle seats with adjustable leg supports and/or lower leg support devices are known from the prior art.

The invention is based on the object of improving a seat, in particular a vehicle seat, having a leg support of the kind referred to above.

### SUMMARY

This object is achieved according to the invention by a seat, in particular a vehicle seat, having the features of claim 1.

The seat according to the invention, in particular a vehicle seat, comprises at least one seat part and a leg support movably arranged on the seat part, which is adjustable between an extended lengthening position and a retracted normal position. The leg support comprises at least one support form part that is movably arranged relative to the seat part, a form part covering arranged on the support form part and a tensioning device, wherein the tensioning device is configured to keep the form part covering under tension on the support form part in each of two opposing directions of movement during a movement of the support form part relative to the seat part.

By configuring the tensioning device to keep the form part covering under tension on the support form part in each of two opposing directions of movement while the support form part moves relative to the seat part, a consistent tension can be maintained in the form part covering throughout the adjustment of the support form part. This allows the form part covering to be rolled and unrolled on the support form part while maintaining constant tension.

The form part covering can form a taut, flat surface, in particular a bearing surface, throughout the entire adjustment movement of the support form part. A tensioning device of this kind facilitates a compact and cost-effective design for maintaining the tension of the form part covering.

Advantageous embodiments that can be used individually or combined with one another are the subject matter of the dependent claims.

The tensioning device is configured to keep the form part covering under tension on the support form part in a first direction of movement, particularly an extension direction (in the X-direction), during a movement of the support form part from the retracted normal position into the extended lengthening position.

The tensioning device is configured to keep the form part covering under tension on the support form part in a second direction of movement, particularly a retraction direction (in the X-direction), during a movement of the support form part from the extended lengthening position into the retracted normal position.

The support form part, such as a support moulded part may form a front seat section of the seat part. The support form part may form a lengthening section of the seat part. In the normal position, the support form part may have a support segment that partially overlaps the seat part, in particular a front seat part section of the seat part. When the support form part is extended, the overlapping area between the support segment of the support form part and the front section of the seat part decreases.

In this case, the form part covering can be held in place by the tensioning device in such a way that the form part covering is kept under tension along the support form part in both directions of movement. The form part covering may, for example, be a laminate and/or a composite laminate. The tension exerted on the form part covering can be maintained consistently throughout the length of the travel path of the support form part. This prevents a reduction in tension in one of the directions of movement, for example during a backwards movement of the support form part.

By moving the support form part relative to the seat part, the size of the bearing surface of the form part covering for a user sitting on the seat can be adjusted.

The leg support, which is designed, for example, as a thigh support, comprises at least one support form part, a form part covering arranged on the support form part in a movable manner, particularly in a sliding manner, and a tensioning device, which is configured to keep the form part covering movable and pre-tensioned on the support form part in two opposing directions of movement, wherein the tensioning device comprises at least one tensioning element, particularly a tensioning strap, which is secured at least at one fastening point fixed to the seat and one fastening point fixed to the form part covering and is movably guided between the fastening points at least at two deflection points along a form part contour of the support form part.

A deflection point can be understood, for example, as a general deflection location or deflection area. The deflection point may, for example, be formed by a suitable guiding section or fixing section.

The leg support, in particular the support form part, may form a front part of the seat part. The seat part may, in particular, be designed as a multi-part structure. For example, the seat part can include a front movable seat part, particularly forming the support form part, and a rear stationary seat part providing a seating surface for a user of the seat.

The leg support may be movable, for example, along a travel path in the X-direction, for example by 80 mm, particularly relative to the stationary seat part. A seat cushion or seat padding may be arranged on the seat part. The seat cushion or seat padding may be particularly designed to extend the seat cushion of the seat part by the value of the travel path through the movement, particularly the displacement, of the leg support in the X-direction. In this process, the form part covering, which may include at least one foam component and/or a trim component, can glide over the support form part when the support form part is extended. The leg support may be designed as an extension of the seat part.

To ensure that the form part covering, for example in the form of a laminate, unrolls in a dimensionally stable manner over the support form part, the form part covering is kept under tension throughout the entire movement of the support form part.

The tensioning device may be designed as a reverse-roll mechanism. The leg support may form a form part covering and seat cushion extension. The leg support may also include a reversibly configured rolling mechanism for adjusting the seat depth.

The tension or length compensation is generated by the tensioning device. The tensioning element may be a tension strap, such as a tie-down strap. As the travel path lengthens, the tension on the tensioning element may increase, wherein during a reverse movement of the support form part, a reduction in the tension of the form part covering is to be avoided. The tensioning element may be a strap, in particular a tensioning strap, or a band. The tensioning element may be designed to be non-flexible. It may be configured to glide along the support form part during the movement of the support form part relative to the seat part.

Traditionally, flexible materials and/or spring elements are used to maintain the tension of a form part covering, wherein the tension on the flexible material is also increased with the length of the travel path and can decrease correspondingly during the reverse movement.

To counteract this process and ensure consistent tension throughout the entire travel path, it is necessary to reverse the travel path in the X-direction and simultaneously utilize the travel movement in both directions, X1 and X2.

By securing the tensioning element, at least at one fastening point fixed to the seat and one fastening point fixed to the form part covering, and guiding it movably at at least two deflection points along the contour of the support form part, the tension of the form part covering can be maintained throughout the entire extension movement and retraction movement of the support form part.

By securing the tensioning element at least at one fastening point fixed to the seat and one fastening point fixed to the form part covering, and guiding it movably along a form part contour of the support form part at at least two deflection points, both the extension process and the reverse extension process, in other words the retraction process, can occur with largely consistent tension on the form part covering at the support form part.

At least one guiding element may be formed on the support form part, in which the tensioning element is at least partially guided. The tensioning element may be guided along sections of an upper surface side and sections of an opposing lower surface side of the support form part.

The tensioning element may follow a kind of S-bend. The tensioning element may be arranged to run substantially in an S-shape, particularly along the form part contour of the support form part. The tensioning element may be arranged on the support form part in such a manner that it can be deflected at the support form part at least once, preferably multiple times, particularly in an S-shaped manner. S-shaped deflection means that the tensioning element follows an S-bend path.

The tensioning element may be secured to a fixed part of the seat, for example the seat part. This fastening point overlaps, along a section of the travel path, with one of the deflection points on the movable support form part in the retracted normal position, for example, in a retracted state.

The support form part may have a first support section, for example a thigh support section, a second support section, for example a lower leg support section, and a connecting section linking the support sections, wherein a first deflection point is formed at one end of the first support section and a second deflection point is formed in the region of the connecting section. The connecting section may have a shape following an ergonomic curve or bend, for example in the knee area.

The tensioning element is deflected at a first deflection point on the movable support form part and guided to a second deflection point, forming the S-bend.

The support form part may have a third deflection point formed at one end of the second support section.

During the movement of the support form part, the direction of travel can be reversed, wherein the tensioning element is released during the extension of the support form part and retracted during the reverse movement.

One end of the tensioning element may be connected to a fixed layer of the form part covering, for example of a trim laminate. The tensioning element may be designed to guide the form part covering over the support form part.

### DESCRIPTION OF THE FIGURES

The invention is explained in greater detail below using advantageous exemplary embodiments illustrated in the figures. However, the invention is not limited to these exemplary embodiments. In the drawings:

FIG. 1: shows a schematic representation of a vehicle seat with a longitudinal adjustment mechanism according to the prior art,

FIG. 2: shows a perspective view of a leg support with at least one support form part, a form part covering and a tensioning device,

FIG. 3: shows another perspective view of the leg support,

FIG. 4: shows a perspective view of a leg support arranged on a seat part,

FIG. 5: shows a perspective view of the leg support arranged on the seat part in a retracted normal position,

FIG. 6: shows a perspective view of the leg support arranged on the seat part in an extended lengthening position,

FIG. 7: shows a perspective view of a support form part with two tensioning elements,

FIG. 8: shows another perspective view of the support form part,

FIG. 9: shows a perspective view of the leg support in a retracted normal position,

FIG. 10: shows a perspective view of the leg support in an extended position.

### DETAILED DESCRIPTION

Parts corresponding to one another are identified using the same reference signs across all figures.

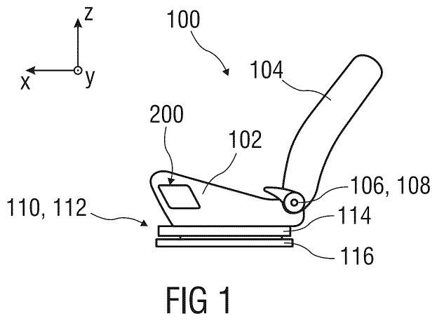

A vehicle seat 100, schematically depicted in FIG. 1 in the prior art, is described below using three mutually perpendicular spatial directions. A longitudinal direction x runs predominantly horizontally for a vehicle seat 100 installed in a vehicle, preferably parallel to a longitudinal direction of the vehicle, which corresponds to the usual direction of travel of the vehicle. A transverse direction y, perpendicular to the longitudinal direction x, is also horizontally aligned in the vehicle and runs parallel to the transverse direction of the vehicle. A vertical direction z runs perpendicular to both the longitudinal direction x and the transverse direction y. For a vehicle seat 100 installed in the vehicle, the vertical direction z preferably runs parallel to the vertical axis of the vehicle.

The positional and directional references used, such as front, back, top and bottom, are based on the viewing direction of a passenger seated in the vehicle seat 100 in a normal sitting position, wherein the vehicle seat 100 is installed in the vehicle in a usage position suitable for passenger transportation, with the backrest 104 upright and, as usual, oriented in the direction of travel. However, the vehicle seat 100 may also be installed or moved in an orientation different from the direction of travel, for example, transversely to the direction of travel. Unless stated otherwise, the vehicle seat 100 is constructed symmetrically with respect to a plane perpendicular to the transverse direction y.

The backrest 104 may be pivotably arranged on a seat part 102 of the vehicle seat 100. For this purpose, the vehicle seat 100 may optionally comprise a fitting 106, in particular an adjustment fitting, rotary fitting, locking fitting or tilt fitting.

The positional and directional references used, such as radial, axial and circumferential, for example, relate to a rotational axis 108 of the fitting 106. Radial means perpendicular to the rotational axis 108. Axial means in the direction of, or parallel to, the rotational axis 108.

The vehicle seat 100 may optionally comprise a longitudinal adjustment mechanism 110. The longitudinal adjustment mechanism 110 comprises, for example, a rail arrangement 112 with a first rail element 114 and a second rail element 116. The first rail element 114 is adjustable relative to the second rail element 116 in the longitudinal direction x. The first rail element 114 is attached to the seat part 102. The second rail element 116 is attached to a structural element of a vehicle, for example a vehicle floor.

For greater clarity, the first rail element 114 is referred to as the upper rail 114 in the following description. This upper rail 114 (also called a running rail or carriage) is assigned to the vehicle seat 100 and configured to support this vehicle seat 100. The second rail element 116 is further referred to as the lower rail 116. The lower rail 116 is fixed and connected, for example, to the floor of a vehicle.

To enhance seating comfort, the seat part 102 may be provided with an extendable and/or movable leg support 200.

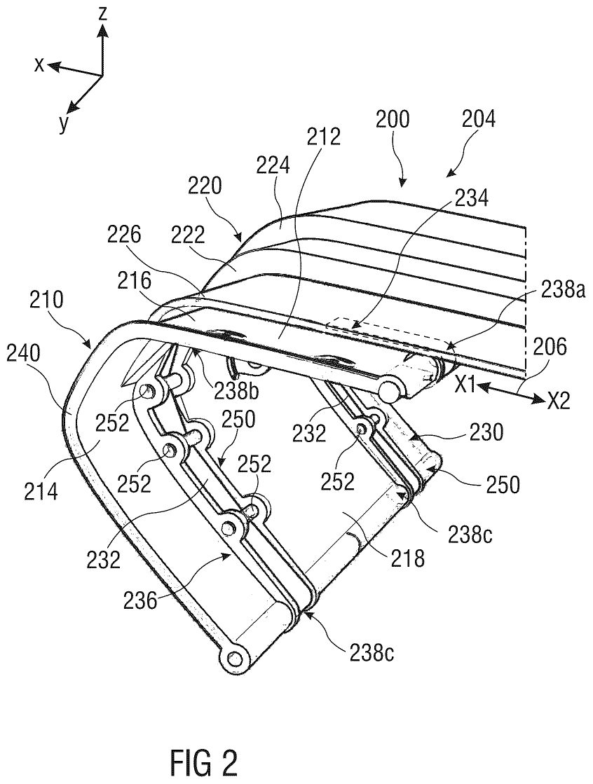

FIG. 2 shows a perspective view of a leg support 200 with at least one support form part 210, a form part covering 220 and a tensioning device 230 for tensioning the form part covering 220 on the support form part 210.

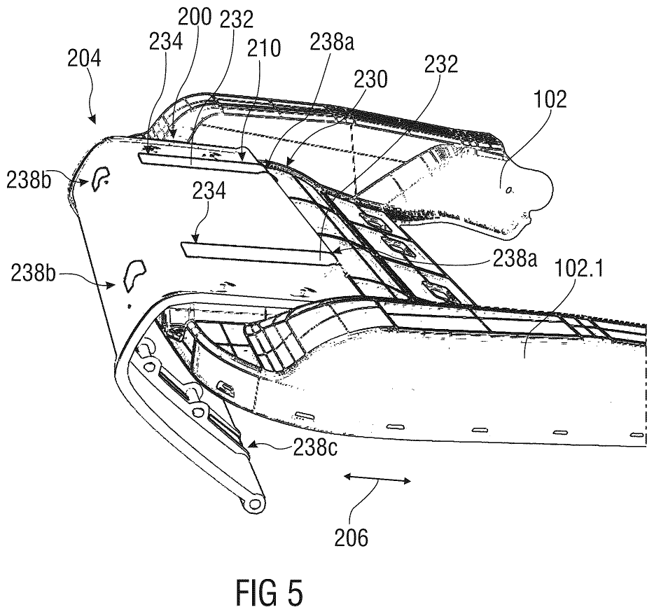

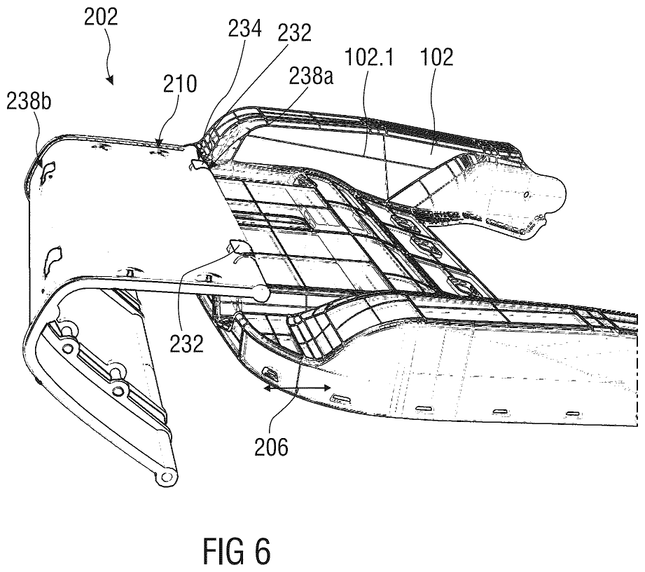

The seat part 102 comprises a leg support 200 that is movably or adjustably arranged on the seat part 102 and is adjustable between an extended lengthening position 202 (shown in FIG. 6) and a retracted normal position 204 (shown in FIG. 5). The leg support 200 can be variably adjusted between the normal position 204 and the fully extended lengthening position 202. For example, a plurality of intermediate positions may be adopted.

The leg support 200 comprises at least one support form part 210. The support form part 210 may be an injection-form part. The support form part 210 may be movably arranged at the front part of the seat part 102. The support form part 210 can form the front section of the seat part 102. The support form part 210 may be designed to be movable, particularly adjustable and/or extendable, relative to a seat cushion or seat padding arranged on the seat part 102, in particular on a frame section of the seat part 102.

The support form part 210 may be substantially L-shaped, J-shaped or U-shaped in design. The support form part 210 may have at least a first support section 212 and a second support section 214 bent relative to the first support section 212. For example, the first support section 212 may provide support for a passenger's thigh. The second support section 214 may, for example, provide support for a knee region, for example the back of the knee, and/or a lower leg region.

The leg support 200 comprises a form part covering 220 that is movable relative to the support form part 210, particularly in a sliding manner. The form part covering 220 may be a laminate. For example, the form part covering 220 may comprise at least one foam layer 222, a covering layer 224, for example a trim and/or upholstery layer, and a sliding material layer 226, for example a felt layer and/or a fleece material layer and/or a layer made of thermo-felt. The form part covering 220 may be partially connectable to, or connected to, the support form part 210. During a movement of the support form part 210 relative to the seat part 102, particularly along a travel path 206 in the X-direction, the form part covering 220 may slide and/or roll along a surface side 216 of the support form part 210.

The tensioning device 230 is configured to keep the form part covering 220 movable and pre-tensioned in two opposing directions, X1 and X2, on the support form part 210. The tensioning device 230 may comprise at least one tensioning element 232, in particular a tensioning strap. In the exemplary embodiment shown, the tensioning device 230 comprises two tensioning elements 232 that are arranged spaced apart from one another in the transverse direction of the support form part 210.

Each tensioning element 232 is attached at a fastening point fixed to the seat 234 and at a fastening point fixed to the form part covering 236. The fastening points 234, 236 are arranged on the surface side 216. The respective fastening point fixed to the seat 234 can connect the corresponding tensioning element 232 to the seat part 102, for example to a seat frame part. The respective fastening point fixed to the form part covering 236 can connect the corresponding tensioning element 232 to the form part covering 220, in particular to an underside and/or lower layer of the form part covering 220. In particular, the respective fastening point fixed to the form part covering 236 can connect the corresponding tensioning element 232 to the sliding material layer 226.

For example, the foam layer 222, the covering layer 224 and the sliding material layer 226 can be connected to one another, for example laminated and/or glued.

Between the respective fastening points 234, 236, the associated tensioning element 232 is movably guided at least at two deflection points 238a, 238b along a form part contour 240 of the support form part 210.

A deflection point 238a, 238b may refer to a general deflection location or a deflection area. Each deflection point 238a, 238b may be formed, for example, by a suitable guide section or attachment section.

The respective tensioning element 232 is arranged on the support form part 210, in particular deflected, in such a manner that the respective tensioning element 232 runs along both the surface side 216 and along an underside 218 of the support form part 210.

The respective tensioning element 232 is deflected in such a manner that it follows a substantially S-shaped path (in cross section) or forms an S-bend. This ensures consistent tensioning of the form part covering 220 throughout the entire travel path 206 in both directions of movement, X1 and X2.

The respective tensioning element 232 is guided along a form part contour 240 of the support form part 210. The form part contour 240 may substantially follow an L-shaped, J-shaped or U-shaped path.

The respective tensioning element 232 may be a tension strap, such as a webbing strap.

The respective tensioning element 232 is attached to a fixed part of the seat. In the depicted normal state 204 of the leg support 200, the fastening point fixed to the seat 234 overlaps a distance of the travel path 206 with the first deflection point 238a of the movable support form part 210.

The respective tensioning element 232 is redirected around the first deflection point 238a and guided back to the second deflection point 238b. The deflection points 238a and 238b can be formed by bearing elements. On the underside 218 of the support form part 210, two guide elements 250, such as guide tracks and/or guide grooves, can be formed, with each tensioning element 232 being guided within one of the guide elements 250 after the first deflection. The guide elements 250 may each include a number of guide rollers 252.

The respective tensioning element 232 may be connected to the form part covering 220 at the first fastening point 234 and run along an upper side of the support form part 210 in a first section. After the first deflection, each tensioning element 232 runs along the underside of the support form part 210 in a second section until it reaches the second deflection point 238b. At the second deflection point 238b, the respective tensioning element 232 partially runs along the upper side of the support form part 210, before being redirected back towards the underside 218 of the support form part 210 to form the S-bend. At a third deflection point 238c, for example at a lower end of the support form part 210, each tensioning element 232 can again be redirected towards the upper side 216 of the support form part 210 to connect to the form part covering 220 at the second fastening point 236.

During the movement of the support form part 210, the travel path 206 is reversed, wherein the respective tensioning element 232 is released during the extension of the support form part 210 and retracted in the opposite direction of movement X2.

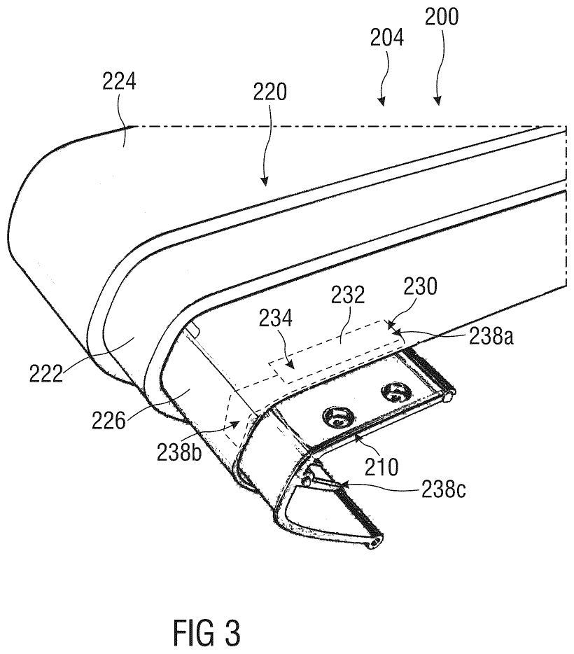

FIG. 3 shows another perspective view of the leg support 200.

The leg support 200 comprises at least one support form part 210. The support form part 210 may be an injection-form part. The support form part 210 can be movably arranged at the front part of the seat part 102. The support form part 210 can form the front section of the seat part 102. The support form part 210 may be configured to be movable, in particular adjustable and/or extendable, relative to a seat cushion or seat padding arranged on the seat part 102, particularly on a frame section of the seat part 102.

The support form part 210 may be substantially L-shaped, J-shaped or U-shaped. The support form part 210 may have at least a first support section 212 (shown in FIG. 2) and a second support section 214 (shown in FIG. 2) bent relative to the first support section 212. For example, the first support section 212 may provide support for a passenger's thigh. The second support section 214 may, for example, provide support for a knee region, for example the back of the knee, and/or a lower leg region.

The leg support 200 comprises a form part covering 220 that is movable relative to the support form part 210, particularly in a sliding manner. The form part covering 220 may be a laminate. For example, the form part covering 220 may comprise at least one foam layer 222, a covering layer 224, for example a trim and/or upholstery layer, and a sliding material layer 226, for example a felt layer and/or a fleece material layer and/or a layer of thermo-felt. The form part covering 220 may be partially connectable to, or connected to, the support form part 210. During a movement of the support form part 210 relative to the seat part 102, particularly along a travel path 206 in the X-direction, the form part covering 220 may slide and/or roll along a surface side 216 of the support form part 210.

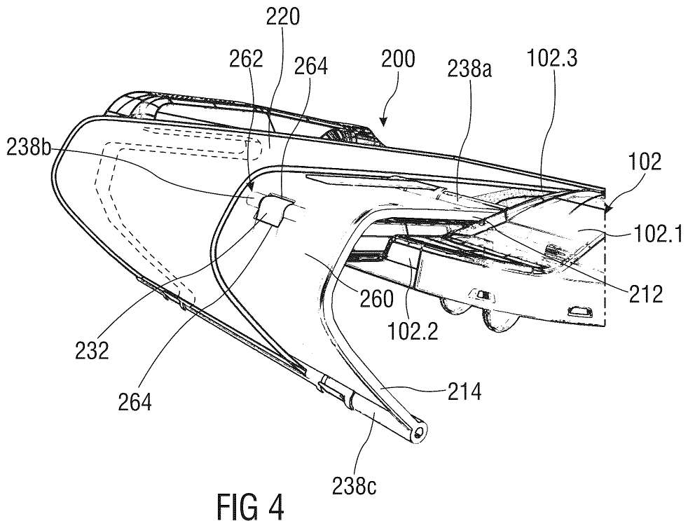

FIG. 4 shows a perspective view of a leg support 200 arranged on a seat part 102.

For example, the seat part 102 may comprise at least one seat shell 102.1, in particular a seat cushion shell. In a front section 102.2 of the seat shell 102.1, the leg support 200 may be arranged on the seat part 102.

The form part covering 220 can be attached at one end to the seat part 102, for example to a rear section of the seat part, in other words in a rear section 102.3 of the seat part 102. The form part covering 220 may be part of a seat covering, for example.

The support form part 210 comprises at least a first support section 212, for example a thigh support section and a second support section 214, for example a lower leg support section. In addition, the support form part 210 comprises a connecting section 260 that connects the support sections 212 and 214. The connecting section 260 may have a shape corresponding to an ergonomic bend or curve. The support form part 210 may be designed to be substantially U-shaped or L-shaped.

A first deflection point 238a is located at a free end of the first support section 212. The first deflection of the tensioning element 232 occurs at a rounded free end of the first support section 212. A second deflection point 238b is located in the region of the connecting section 260. In particular, the second deflection point 238b is formed by the connecting section 260. A bending point, particularly a curvature point 262, of the connecting section 260 is provided with two spaced openings 264, for example, through which the tensioning element 232 can be guided. The second deflection of the tensioning element 232 occurs at the curvature point 262 of the connecting section 260. The support form part 210 comprises a third deflection point 238c arranged at a free end of the second support section 214. The third deflection of the tensioning element 232 takes place at a rounded free end of the second support section 214.

The tensioning element 232 is arranged on the support form part 210, in such a manner that it is redirected multiple times on the support form part 210, in particular in an S-shaped or wave-like manner.

FIG. 5 shows a perspective view of the leg support 200 arranged on the seat part 102 in a retracted normal position 204. FIG. 6 shows a perspective view of the leg support 200 arranged on the seat part 102 in an extended lengthening position 202. The leg support 200, in particular the support form part 210, may form the front part of the seat part 102 and be movable along a travel path 206 in the X-direction, for example by 80 mm. This allows a seat cushion of the seat part 102 to be extended by the length of the travel path 206. The form part covering 220 can glide over the support form part 210 as the support form part 210 extends. The leg support 200 can act as a seat part extension. When the support form part 210 extends, the first deflection point 238a moves closer to the first fastening point 234, while the second deflection point 238b moves further away from the first fastening point 234. When the support form part 210 retracts, the distance between the first deflection point 238a and the first fastening point 234 increases, while the distance between the second deflection point 238b and the first fastening point 234 decreases. Because the tensioning element 232 follows an S-bend or S-shape along the support form part 210, the movement of the support form part 210 can maintain a largely constant tension on the form part covering 220 along the support form part 210.

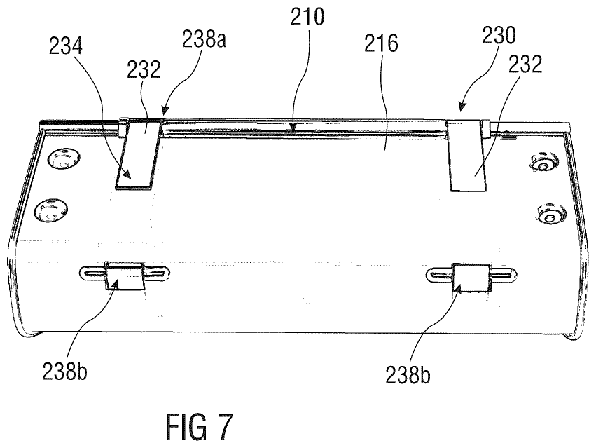

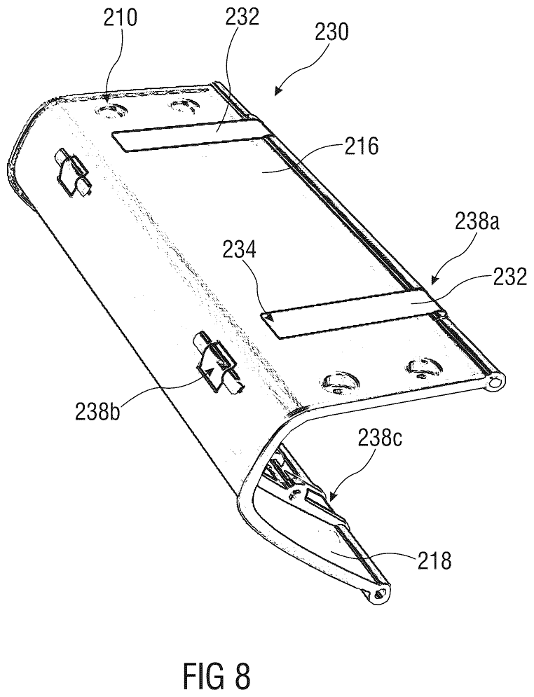

FIG. 7 shows a perspective view of a support form part 210 with two tensioning elements 232 and FIG. 8 shows another perspective view of the support form part 210.

The tensioning device 230 is configured to keep the form part covering 220 under tension on the support form part 210 in two opposing directions X1 and X2. The tensioning device 230 may comprise at least one tensioning element 232, in particular a tension strap. In the exemplary embodiment depicted, the tensioning device 230 comprises two tensioning elements 232 which are arranged spaced apart from one another along the transverse direction of the support form part 210.

The respective tensioning element 232 is attached at a fastening point fixed to the seat 234 and at a fastening point fixed to the covering 236. The fastening points 234, 236 are arranged on the surface side 216. The respective fastening point fixed to the seat 234 can connect the respective tensioning element 232 to the seat part 102, for example to a seat frame part. The respective fastening point fixed to the covering 236 can connect the associated tensioning element 232 to the form part covering 220, in particular to an underside and/or lower layer of the form part covering 220.

Between the respective fastening points 234 and 236, the associated tensioning element 232 is movably guided at least at two deflection points 238a and 238b along a form part contour 240 of the support form part 210.

The respective tensioning element 232 is arranged on the support form part 210, in particular deflected, in such a manner that the respective tensioning element 232 runs along both the surface side 216 and along an underside 218 of the support form part 210.

The respective tensioning element 232 is deflected in such a manner that it has a substantially S-shaped course (in cross section) or forms an S-bend. This ensures a consistent tension on the form part covering 220 throughout the entire travel path 206 in both directions of movement X1 and X2.

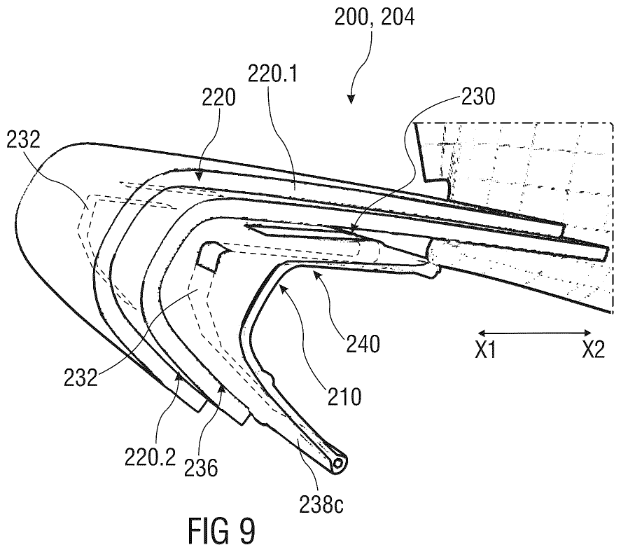

FIG. 9 shows a perspective view of the leg support 200 in a retracted normal position 204.

As described earlier, the leg support 200 comprises at least one support form part 210 arranged movably relative to the seat part 102, a form part covering 220 arranged to slide on the support form part 210 and a tensioning device 230. The tensioning device 230 is configured to maintain the form part covering 220 on the support form part 210 under tension, particularly under consistent tension, during the movement of the support form part 210 relative to the seat part 102 in either of the two opposing directions of movement X1 or X2.

By moving the support form part 210 relative to the seat part 102, a bearing surface area of the form part covering 220 for a user sitting on the seat 100 can be adjusted. In the retracted normal position 204, a bearing area 220.1 formed by the form part covering 220 is made smaller.

The tensioning element 232 or tensioning elements 232 of the tensioning device 230 is/are guided movably along the form part contour 240 of the support form part 210, wherein the respective tensioning element 232 is movable along with the movement of the support form part 210 relative to the seat part 102 in such a manner that the form part covering 220 is held, or remains, under tension. The respective tensioning element 232 may be designed as a strap or belt.

In the retracted normal position 204, the form part covering 220 lies on the support form part 210 in such a manner that a front covering end 220.2 of the form part covering 220 is arranged close to the third deflection point 238c.

In other words, in the retracted normal position 204, the fastening point fixed to the form part covering 236, which connects the form part covering 220 to the tensioning element 232, and the third deflection point 238c are arranged close to one another.

By an extension movement of the support form part 210 away from the seat part 102 (in direction of movement X1), the form part covering 220 can be tensioned and/or unrolled on the support form part 210 in such a manner that the front covering end 220.2 and/or the fastening point fixed to the covering 236 can move away from the third deflection point 238c.

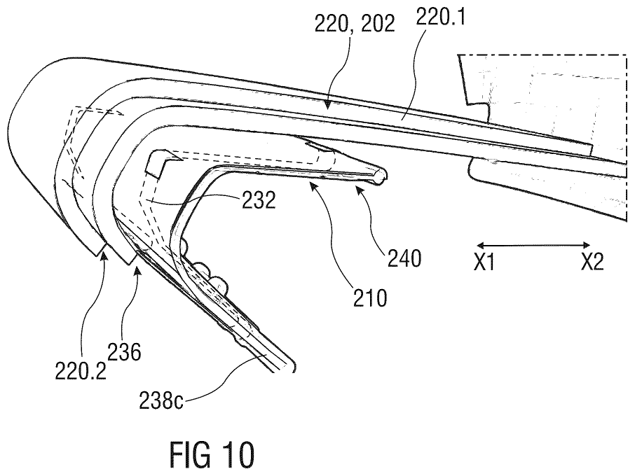

FIG. 10 shows a perspective view of the leg support 200 in an extended position 202.

In the extended lengthening position 202, a bearing surface 220.1 formed by the form part covering 220 is made larger.

The tensioning element 232 or tensioning elements 232 of the tensioning device 230 is/are movably guided along the form part contour 240 of the support form part 210, wherein the respective tensioning element 232 is movable along with the movement of the support form part 210 relative to the seat part 102 in such a way that the form part covering 220 is held, or remains, under tension. The respective tensioning element 232 may be designed as a strap or belt.

In the extended lengthening position 202, the form part covering 220 lies on the support form part 210 in such a manner that the front covering end 220.2 of the form part covering 220 is arranged at a greater distance from the third deflection point 238c. As the support form part 210 moves away from the seat part 102, the distance between the front covering end 220.2 and the third deflection point 238c increases.

In other words, in the extended lengthening position 202, the fastening point fixed to the form part covering 236, which connects the form part covering 220 to the tensioning element 232, and the third deflection point 238c are arranged far apart from one another.

By a retraction movement of the support form part 210 towards the seat part 102 (in direction of movement X2), the form part covering 220 can be tensioned and/or unrolled on the support form part 210 in such a manner that the front covering end 220.2 and/or the fastening point fixed to the covering 236 can move closer to the third deflection point 238c.

This ensures consistent tensioning of the form part covering 220 throughout the entire travel path 206 in both directions of movement X1 and X2.

### LIST OF REFERENCE SIGNS

100 vehicle seat
102 seat part
102.1 seat shell
102.2 front section
102.3 rear section
104 backrest
106 fitting
108 rotational axis
110 longitudinal adjustment mechanism
112 rail arrangement
114 first rail element (upper rail)
116 second rail element (lower rail)
200 leg support
202 extended lengthening position
204 normal position
206 travel path
210 support form part
212 first support section
214 second support section
216 surface side
218 underside
220 form part covering
220.1 bearing surface
220.2 front covering end
222 foam layer
224 covering layer
226 sliding material layer
230 tensioning device
232 tensioning element
234, 236 fastening point
238a, 238b, 238c deflection point
240 form part contour
250 guide element
252 guide roller
260 connecting section
262 curvature point
264 opening
X1, X2 direction of movement
x longitudinal direction
y transverse direction
z vertical direction

1. A vehicle seat having at least one seat part and a leg support movably arranged on the seat part, which is adjustable between an extended lengthening position and a retracted normal position,
characterized in that
the leg support comprises at least:
a support form part movably arranged relative to the seat part,
a form part covering arranged on the support form part and
a tensioning device,
wherein the tensioning device is configured to keep the form part covering under tension on the support form part in each of two opposing directions of movement during a movement of the support form part relative to the seat part.

2. The seat according to claim 1, characterized in that by moving the support form part relative to the seat part, the size of the bearing surface of the form part covering for a user sitting on the seat can be adjusted.

3. The seat according to claim 1, characterized in that the tensioning device comprises at least one tensioning element arranged on the support form part, which has a fastening point fixed to a seat part at a first end and a fastening point fixed to a covering at an opposite second end.

4. The seat according to claim 3, characterized in that the tensioning element is a strap or a belt.

5. The seat according to any one of claim 3, characterized in that the tensioning element is movably guided along a form part contour of the support form part, wherein the tensioning element is movable along with the movement of the support form part relative to the seat part in such a manner that the form part covering is held, or remains, at a constant tension.

6. The seat according to claim 3, characterized in that at least one guiding element is provided on the support form part, in which the tensioning element is at least partially guided.

7. The seat according to claim 3, characterized in that the tensioning element is arranged on the support form part in such a manner that it is deflected on the support form part at least once in an S-shaped manner.

8. The seat according to claim 3, characterized in that the tensioning element is arranged on the support form part in such a manner that it is deflected on the support form part multiple times in an S-shaped manner.

9. The seat according to claim 3, characterized in that the support form part has at least two deflection points, at which the tensioning element is deflectable or deflected.

10. The seat according to claim 7, characterized in that the support form part has a first support section, a second support section and a connecting section linking the support sections, wherein a first deflection point is formed at one end of the first support section and a second deflection point is formed in the region of the connecting section.

11. The seat according to claim 9, characterized in that the support form part has a third deflection point, which is arranged at one end of the second support section.
